(19) United States
(12) Patent Application Publication
(10) Pub. No.: US 2013/0139063 A1
(43) Pub. Date: May 30, 2013

(54) METHOD AND SYSTEM FOR ASSISTING WITH COLOUR SELECTION

(71) Applicants: Christophe Senot, Nozay (FR); Yann Toms, Nozay (FR); Stéphane Betge-Brezetz, Nozay (FR); Armen Aghasaryan, Nozay (FR)

(72) Inventors: Christophe Senot, Nozay (FR); Yann Toms, Nozay (FR); Stéphane Betge-Brezetz, Nozay (FR); Armen Aghasaryan, Nozay (FR)

(21) Appl. No.: 13/508,089

(22) PCT Filed: Nov. 22, 2010
(86) PCT No.: PCT/FR2010/052468

§ 371 Date: Jul. 27, 2012

(30) Foreign Application Priority Data
Nov. 23, 2009 (FR) 0905619

(51) Int. Cl. G06F 3/0484

(52) U.S. Cl. CPC G06F 3/0484
USPC 715/730

(57) ABSTRACT

Method for colour selection assistance for the preparation of visual aids, taking into account at least one profile influencing the selection of colours, one lesson about a colour, one colour combination rule, and one piece of information about the structure of the visual aid.

This invention relates to the technical field of computer presentation resources.

Here, “computer presentation resources” refers to any computer program product with the help of which one can produce a visual aid or more generally an electronic document or computer data that one can present visually to an audience. Microsoft Office Word™, Microsoft Office PowerPoint™, OpenOffice™, Keynote™, KPresenter, Adobe Flash™, Adobe Dreamweaver™, and LATEX (Beamer) are examples of computer presentation resources.

Most of these computer presentation resources offer templates that the user can customise, or even the possibility of designing new templates. To do this, they provide the user with the means for exploring a presentation template such as layout, formatting, and a range of tools (drawings, graphics, tables, flow charts, and multimedia objects).

In particular, these computer presentation resources offer a wide selection of predefined colours (colour palettes, colour codes, textures, and patterns) as well as many colour functions (lighten, blend, tint, brighten, darken, and contrast) allowing the creation of customised colour sets.

However, the judicious selection of colours is a major and complex problem for creating a successful electronic document. In fact, colour is not just a means of visual recognition for human beings. Colour is also a means of comprehension, memorisation, appropriation, legibility, and assessment of the content of a visual aid.

Colour selection is complex because it depends upon several parameters such as
The culture of the viewing audience for an electronic document. In fact, the interpretation of a colour corresponds in general to emotions or symbols that differ from one culture to another. As an example, the colour red commonly symbolises purity in Indian culture, danger in European culture, good luck in Chinese culture, and life in Japanese culture. Also, the colour white reflects peace in European culture, sadness in Indian culture, and death in Chinese culture;
The preferences/tastes of the author of an electronic document (preferences, age, gender);
The general subject of the content (agriculture, automobile industry, sport, health) as well a the context/goal of the presentation (commercial, scientific, academic);
Constraints due to a given graphic charter (brand colours, corporate presentation template);
The presentation environment (the presentation method, lighting, and dimensions of the presentation site).

Additionally, colours must be used coherently (contrast, harmony) throughout an electronic document.

One object of the present invention is to propose a colour selection assistant.

Another object of the present invention is to propose a means of verifying the harmony of the colours present in an electronic document.

Another object of the present invention is to consider colour as one of the basic ergonomic rules in an electronic document.

To that end, the invention proposes, according to a first aspect, a method for displaying an electronic document from an author containing the following to a viewer:
a. The presentation of a chromatic circle using a graphical user interface;
b. Saving an author profile (1) containing user preferences for colours from the chromatic circle and colour combinations;
c. Saving a viewer profile (2) containing the viewer's expected colour preferences;
d. Saving a presentation environment profile (4) containing the display constraints for the electronic document;
e. Verification of the coherence among the information contained in the profiles (1, 2, 4) and the compilation of this information;
f. Querying a database of colour lessons (11) for the compiled information;
g. The development of a profile for the electronic document;
h. A semantic analysis (7) of the content of the electronic document being drafted, this semantic analysis providing information including the document type, document structure, and semantic interpretations of the document content;
i. Querying colour arrangement and combination rules contained in a database (21);
j. Presentation of colours meeting the profile and the semantic information for the elements of the current electronic document to the user through an interactive graphical interface;
k. User selection of a colour or colour combination;
l. Updating the author profile (1) through machine learning comprising a continuous analysis of the user's colour selections;
m. The verification of the coherence of the colours and colour combinations selected by the user throughout the electronic document with the display constraints contained in the environment profile (4);
n. The verification of the coherence of the colours and colour combinations selected by the user throughout the electronic document with the arrangement and combination rules contained in the database (21);
o. The display of the author's electronic document to the viewer.

The invention proposes, according to a second aspect, a display assistant for an author's electronic document to implement the method according to claim 1 or 2, this assistant comprises:
a. A database of colour lessons (11),
b. A database (21) of colour arrangement and combination rules,
c. An interactive graphical interface,
d. A synthesis module (10) to verify coherence among the information contained in profiles (1, 2, 4, 5), to compile the information contained in the profiles (1, 2, 4, 5), to query the information database (11), and to prepare a profile for the electronic document;
e. A semantic structure analyser (7) for the content of the current electronic document, this structural analyser providing information including the document type, document structure, and semantic interpretations of the document content;
f. An adviser (20) proposing colours consistent with the profiles (1, 2, 4, 5) and colour arrangement and combination rules contained in the database (21),
g. A module for verifying (40) the coherence of the colours or colour combinations with the profiles (1, 2, 4, 5).

Advantageously, the colour selection assistant will also comprise a module for verifying the consistency of the colours used throughout the electronic document.

According to a third aspect, the invention proposes a computer program product implemented on a memory medium, which may be implemented within an information processing unit, and comprises instructions for implementing the method summarized above.

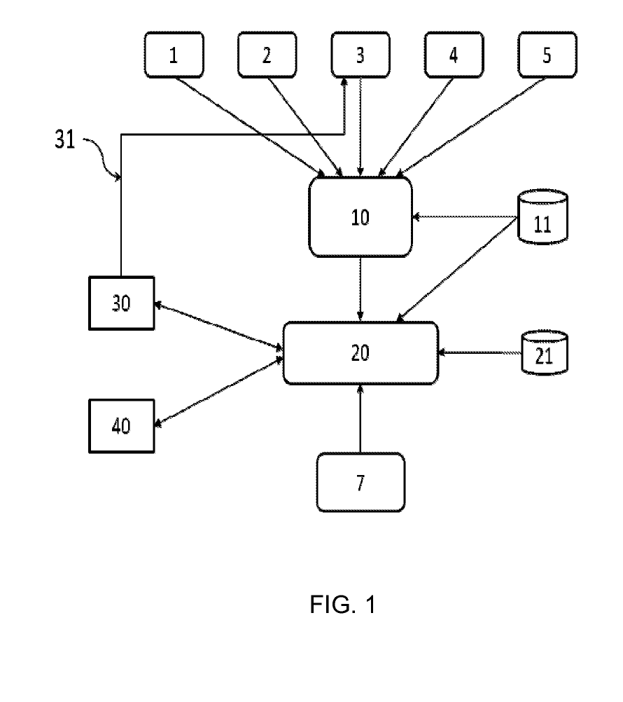

Other characteristics and advantages of the invention will become clearer more specifically after reading the following description of preferred embodiments, with reference to FIG. 1, which graphically illustrates a functional representation of the modules of a colour selection assistant according to one embodiment.

Assisting the user in selecting colours during electronic document preparation is provided through functional modules that may be, in particular, attached to any computer presentation resource.

These modules comprise:
A variety of profiles characterising the various parameters involved in colour selection;
A set of lessons about colours;
Information about the electronic document being modified by the user;
A colour adviser responsible for compiling all information available to it and deducing recommendations from that information to send to the user;
A variety of interactive graphical interfaces to inform the user of a recommended colour, to verify the consistency of the colours used, and to modify certain information used by the colour adviser.

It should be noted that an electronic document is any document designed to be visually presented to an audience, in other words, a visual aid. An electronic document may be a Web site, a poster, a presentation, or a report, for example. In particular, an electronic document may be a Web site designed to be accessible from several regions around the world (a commercial Web site for example).

With reference to FIG. 1, the parameters influencing colour selection will involve:
An author profile 1 for the electronic document;
A viewer profile 2 for the electronic document;
A subject profile 3 for the presentation;
Constraints related to the presentation environment 4;
Constraints related to a potential presentation charter 5.

The author profile 1 helps take the colour and colour combination preferences/tastes of the author of the electronic document into consideration for the colour choice recommendations that will be sent to the author.

The content of the author profile 1 may be established by the user and updated over time using a step involving the machine learning of user preferences by continuously analysing daily user interactions that contain a colour selection step.

For example, through a graphical user interface, the user may be asked to
Order the colours of the chromatic circle according to his or her preferences;
Note the colours of the chromatic circle'
Label colours (“my favourite colour”, “neutral about this colour”, “I hate this colour”, for example);
Make inter-colour comparisons (“I prefer the colour blue to the colour red for example);
Make intra-colour comparisons (“I prefer dark colours”, “I prefer light colours”, “I hate bright colours” for example);
Provide preferences concerning certain colour combinations (“I prefer the combination blue/orange”, “I hate the combination, red/yellow/magenta);
Identify his or her feelings (power, precision, love, sadness, calm, safety, for example) in relation to colours.

The author profile 1 may also contain other information about the user such as age, gender, or region of residence. In particular, this information can help better understand user colour preferences (for example, a child may prefer bright colours, a man may prefer dark colours, a woman may prefer light colours).

Using the information provided by the user and information deduced from user interactions involving colours (machine learning), the author profile 1 is responsible for centralising an updated view of the colour preferences and trends (style effect) of the author of the electronic document.

Advantageously, according to the author profile 1 thus established, colours that the user does not like will have little chance of being listed among the colours recommended by the colour selection assistant.

Advantageously, the machine learning step, which uses the colour selections made by the user during past interactions (arrows 31 on FIG. 1), will make it possible to automatically update the author profile 1.

Additionally, a viewer profile 2 for the electronic document is responsible for synthesizing the preferences of the viewing audience for the presentation of the electronic document. In fact, colours, their blends, and combinations can provoke different emotions, feelings, and symbols from one audience to another. The interpretation of a colour or an association of colours engages a cognitive process in the viewer that can
Trigger emotions such as joy, sadness, or even anger; or
Reveal symbols or brands
   that may or may not provoke a desire among the audience toward the electronic document being presented. As examples, this desire may be manifested by the purchase of a product, in the case of a Web site, or by an interest, in the case of a Microsoft PowerPoint™ presentation.

These emotions/reactions to colours are perceived differently, in particular, according to
The culture of the audience (region, beliefs, or history, for example); and
Demographic data for the audience (male/female, baby/child/adult, vision capacity: daltonism/vision problems, or social/intellectual level for example).

As an example, the colour red symbolises purity in Indian culture, danger in European culture, good luck in Chinese culture, and life in Japanese culture. Also, the colour white reflects peace in European culture, sadness in Indian culture, and death in Chinese culture.

To do this, the author of the document will be asked to provide the information and demographic data necessary to create a viewer profile 2 for the electronic document.

Additionally, to optimise the efficiency of the presentation, the author of the electronic document should provide information about the subject of the presentation, for the subject profile 3 for the visual aid. As an example, the user might be asked to define key words, the topic or context for the electronic document (commercial, educational, informative), the activity sector (Industry, Research & Development, Art, Ecology, for example), and the presentation type (professional/amateur, simple/complex). In fact, a subject profile 3 will preferably call upon specific colour palettes such as bright colours that could evoke the technological or automobile sector, or green colours that might reflect the environmental sector.

In order to take into consideration the various presentation conditions for an electronic document, a presentation environment profile 4 will make it possible to specify constraints related to the presentation environment for the electronic document. These constraints comprise, for example,
The luminosity of the presentation environment;
The means of presentation for this document (user terminal screen, video-projectors (LCD, LCOS, DLP/DMD, Laser), projection screen);
The dimensions of the presentation environment (corners/distances from which colours are no longer clearly distinguishable.

For example, the presentation environment profile 4 can help adapt the colour set to the luminosity of a presentation room; in a room where one has complete control over the lighting, a dark background and light coloured text are recommended, whereas in a room with significant natural light, a light background with dark text will be recommended to the user.

For concordance with predefined graphic charters (corporate presentation templates for example), a presentation charter 5 will centralise constraints related to the use of colours and/or colour combinations (required colours or colour combinations, prohibited colours or colour combinations, required background colours, recommended colour shades, or templates to be used).

A synthesis module 10 will summarize the information available from the author profile 1, viewer profile 2, subject profile 3, presentation environment profile 4, and charter constraints 5.

In particular, the synthesis module 10 will make it possible to
Verify the coherence among the information present in the author profile 1, viewer profile 2, subject profile 3, presentation environment profile 4, and presentation charter constraints 5;
Synthesize (compile) this information;
Query a database of lessons 11 about colours concerning the synthesized information; and
Consequently prepare a profile for the electronic document, to be sent to the colour adviser 20.

It should be noted that in case of an inconsistency in the information recovered from the author profile 1, viewer profile 2, subject profile 3, presentation environment profile 4, and presentation charter constraints 5, the synthesis module 10 will notify the user and then invite him or her to take a decision.

The database of colour lessons 11 will centralise the related effects, symbols, or interpretations concerning colours or colour combinations. As an example,
The colour red orange is a source of vitality, the colour green reassures, the colour pink creates a light-hearted feeling;
The colour green symbolises well-being in Asian culture, the colour red symbolises purity in Indian culture;
A dark body text colour generally promotes concentration.

The colour selection assistant will also comprise an electronic document structure analyser 7. This structure analyser 7 will return semantic information about the content of the current electronic document to the adviser 20. This information comprises
The electronic document type; as non-limiting examples, Web sites, presentations, drafts, reports, advertisements, posters, announcements, or minutes;
The document structure; as non-limiting examples, body text, title, conclusion, lead lines, background, graphs, buttons, menus;
Semantic interpretations of the content of the electronic document; as non-limiting examples, if the words “important”, “attention”, “confirmation”, “conclusion”, or “confidential” are used in the document, at least one lesson from the database of lessons 11 and/or one rule from a database of colour combination rules 21 will be associated with these words. As an example, the colour red may be associated with the word “confidential”.

The database of colour combination rules 21 comprises colour arrangement and combination rules. As an example of colour combination rules, one may cite:
Complementary colours contrast among themselves (creating a dynamic effect to guide the audience);
Similar colours evoke a harmonious and unified feeling in the audience;
A high level of contrast between the background colour and the foreground of the electronic will improve its legibility;
For simple documents, one should use fewer than 3 colours for the text and no more than one background colour;
If using more than one background colour, one should preferably use similar colours instead of complementary colours;
When a colour is used with high transparency, it is important to verify that other colours do not overcome it, and if necessary to adjust its level of transparency (from 0% to 100%);
The combination of black and white makes it possible to modify the perception of volume using a certain layout;
The combination of red and black improves memorisation of the content of an electronic document;
On should use a light background with a dark photo, and vice versa.

Additionally, the colour selection assistant comprises a colour adviser 20. This colour adviser 20 is responsible for proposing suitable colours to the user. First, colours not relevant to the current electronic document will be removed according to
The profile of the current document provided by the synthesis module 10;
The database of colour lessons 11;
The database of colour combination rules 21; and
The document structure analyser 7.

As an example, if the user wants his or her document to portray “power” (information provided by the subject profile 3 for the document), the colour adviser 20 will remove the colours white and pink, purple being more appropriate in this context according to the database of colour lessons 11. The colour adviser 20 will continuously review this first decision according to information returned, for example, from the structural analyser 7 or the database of colour combination rules 21.

Based on colour combination rules, colour lessons, the structure of the document, and the document profile provided by the synthesis module 10, the colour adviser 20 will select colours appropriate for all elements of the electronic document (shapes, surfaces, background, text, drawings, and tables) in terms of colour combinations and arrangement.

In other words, the colour adviser 20 makes it possible to compile (match) all information available to it about the current electronic document. Then the result will be recommended to the user through an interactive graphical user interface 30.

The interactive graphical user interface 30 will automatically relay the colour or colour combination/arrangement recommended by the colour adviser 20 to the user. If the user is undecided among several colours, the colour adviser 20 can propose a limited list of suitable colours, the recommendation of each colour being justified by the colour adviser 20.

The user can save and/or name the colour combinations recommended by the colour adviser 20 for future use.

It should be noted that the user can improve the relevance of the colour adviser 20 by indicating the meaning of the elements of his or her electronic document (body text, titles, circle, or important elements in a diagram), or by customising the content of the database of colour lessons 11.

The graphical user interface 30 is also used to notify the user of any conflicts among the colours used (for example, “this colour combination is prohibited by the presentation charter 5 because it refers to a competitor”).

Alternatively, the colours recommended by the colour adviser 20 can be automatically applied to the various elements of the electronic document, without being proposed via the graphical user interface 30.

The colour selection assistant will also propose a module 40 that the user can implement to verify the consistency of the colours or colour combinations used throughout the electronic document.

The verification module 40 makes it possible to verify the consistency of the colours used with the constraints from the presentation environment profile 4 and the presentation charter 5. As soon as a conflict is identified, the user is asked to review, and potentially modify the colours/colour combinations.

The verification module 40 also makes it possible to verify the consistency and contrast among the colours used throughout the electronic document.

The method and system for colour selection assistance that have just been described can be applied in particular to designing commercial Web sites, e-Learning Web sites, preparing visual aids (posters or PowerPoint™ presentations for example), or more generally any electronic document that may be printed later (such as a newspaper or magazine).

1. A method for displaying an electronic document from an author that comprises:
The presentation of a chromatic circle using a graphical user interface;
Saving an author profile containing user preferences for colours from the chromatic circle and colour combinations;
Saving a viewer profile containing the viewer's expected colour preferences;
Saving a presentation environment profile containing the display constraints for the electronic document;
The verification of the coherence among the information contained in the profiles and the compilation of this information;
Querying a database of colour lessons for the compiled information;
The development of a profile for the electronic document;
A semantic analysis of the content of the electronic document being drafted, this semantic analysis providing information including the document type, document structure, and semantic interpretations of the document content;
Querying colour arrangement and combination rules contained in a database;
The presentation of colours meeting the profile and the semantic information for the elements of the electronic document being prepared to the user through an interactive graphical interface;
User selection of a colour or colour combination;
Updating the author profile through machine learning comprising a continuous analysis of the user's colour selections;
The verification of the coherence of the colours and colour combinations selected by the user throughout the electronic document with the display constraints contained in the environment profile;
The verification of the coherence of the colours and colour combinations selected by the user throughout the electronic document with the arrangement and combination rules contained in the database;
The display of the author's electronic document to the viewer.

2. A method according to claim 1, characterised in that the step involving the verification of the consistency among the information contained in the profiles comprises a verification of consistency with presentation charter constraints.

3. A display assistant for an author's electronic document to implement the method according to claim 1, this assistant comprises:
A database of colour lessons,
A database of colour arrangement and combination rules,
An interactive graphical interface,
A synthesis module to verify coherence among the information contained in profiles, to compile the information contained in the profiles, to query the database of lessons, and to prepare a profile for the electronic document;
A semantic structure analyser for the content of the electronic document being drafted, this structural analyser providing information including the document type, document structure, and semantic interpretations of the document content;
An adviser proposing colours consistent with the profiles and colour arrangement and combination rules contained in the database,
A module for verifying the coherence of the colours or colour combinations with the profiles.

4. A computer program product implemented on a memory medium, which may be implemented within a computer processing unit, and comprises instructions to implement the method according to claim 1.

5. A display assistant for an author's electronic document to implement the method according to claim 2, this assistant comprises:
A database of colour lessons,
A database of colour arrangement and combination rules,
An interactive graphical interface,
A synthesis module to verify coherence among the information contained in profiles, to compile the information contained in the profiles, to query the database of lessons, and to prepare a profile for the electronic document;
A semantic structure analyser for the content of the electronic document being drafted, this structural analyser providing information including the document type, document structure, and semantic interpretations of the document content;
An adviser proposing colours consistent with the profiles and colour arrangement and combination rules contained in the database,
A module for verifying the coherence of the colours or colour combinations with the profiles.

6. A computer program product implemented on a memory medium, which may be implemented within a computer processing unit, and comprises instructions to implement the method according to claim 2.
